(19) United States
(12) Patent Application Publication
(10) Pub. No.: US 2009/0009726 A1
(43) Pub. Date: Jan. 8, 2009

(54) MULTI-PRIMARY-COLOR DIGITAL LIGHT SPLITTING AND COMBINING SYSTEM AND METHOD, AND DIGITAL PROJECTOR

(75) Inventors: Da-Shuang Kuan, Hsinchu County (TW); Chun-Sheng Fan, Hsinchu County (TW); Li-Bin Chang, Hsinchu County (TW); Chia-Te Lin, Chiayi County (TW)

Correspondence Address: J C PATENTS, INC., 4 VENTURE, SUITE 250, IRVINE, CA, 92618, US

(73) Assignee: UNITED MICRODISPLAY OPTRONICS CORP., Hsin-Chu City (TW)

(21) Appl. No.: 11/772,989

(22) Filed: Jul. 3, 2007

(51) Int. Cl. G02B 27/14; G03B 21/13

(52) U.S. Cl. 353/33; 359/634

(57) ABSTRACT

A multi-primary-color light splitting and combining system, includes a dichroic device, receiving an incident light beam and splitting into a first light beam having a first wavelength range and a second light beam having a second wavelength range. The first wavelength range in wavelength value is larger than the second wavelength range. A first polarized beam splitter receives the first light beam and splits out a first polarization beam having a first predetermined polarization state. A second polarized beam splitter receives the second light beam and splits out a second polarization beam having a second predetermined polarization state. A first and a second reflective displaying panels respectively receive the first and second polarization light beams, and reflect first and second sets of image information with respect to multiple primary colors. A polarized beam splitter combines first and second sets of image information to form an image light beam.

### BACKGROUND OF THE INVENTION

1. Field of the Invention

The present invention relates to an image projection technique. More particularly, the present invention relates to a technique of using more primary colors to form an image, so as to effectively improve the image quality.

2. Description of Related Art

A reflective display panel, such as a reflective liquid crystal on silicon (LCOS), is characterized in that most of the driving devices are formed on a lower substrate, and a liquid crystal layer is disposed between the lower substrate and an upper substrate. A light source enters from the upper substrate into the lower substrate, and the light is reflected by a reflective layer of the lower substrate. Therefore, the reflected light will not be shielded by the driving devices, such that the utilization efficiency of the light is improved.

The reflective LCOS can be used to constitute a projection display device. FIG. 1 is a schematic structural view of a conventional projection display device. Referring to FIG. 1, a white light beam 100 is incident on a dichroic mirror 102. The dichroic mirror splits out a blue light beam 106 and a red-green mixed light beam 104 according to the color gamut of the light. The red-green mixed light beam 104 is reflected by a reflecting mirror 108 in the path, so as to enter a desired path direction. Then, the red-green mixed light beam 104 is split into a read light beam 112 and a green light beam 114 by a dichroic mirror 110. The green light beam 114, for example, will enter a polarization beam splitter (PBS) 116. The polarization beam splitter (PBS) 116, for example, reflects the light having an S-polarization state, and allows the light having a P-polarization state to pass through. Therefore, a portion of the light beam having the S-polarization state of the green light beam 114 is deflected by 90° and enters a LCOS 118. The driving device of each pixel of the LCOS 118 will drive rotation degree of the liquid crystal belonging to each pixel. Therefore, the incident green light having the S-polarization state is reflected by the LCOS 118 and then rotated as each pixel is driven, so as to generate the portion having the P-polarization state. Therefore, the portion having the P-polarization state in the reflected green light will pass through the same PBS 116, thereby obtaining a green light image 120, in which the grey level is determined by the degree of the P-polarization state caused by the rotation degree of the liquid crystal.

Furthermore, according to the same mechanism, the red light beam 112 also generates a red image 126 through a PBS 122 and a LCOS 124. Also, according to the same mechanism, the blue light beam 106 also generates a green image 134 through a PBS 130 and a LCOS 132. The green image 120, the red image 126, and the blue image 134 are combined by a light combining mirror 136 to form a color image 138, and then a projection unit 140 is used to, for example, amplify the image to another image 142, and project the image 142 to a display screen (not shown).

The design of the conventional projection display device in FIG. 1 lies in the architecture of three single-color LCOS panels of three original colors, the whole projection system needs a plurality of light paths, thus being complicated. FIG. 2 is a schematic structural view of a conventional multi-color LCOS panel. Referring to FIG. 2, in a reflective displaying panel 202 having three primary colors of red, green and blue, each pixel has three sub-pixels of red, green and blue, which respectively generate a grey level corresponding to red, green, and blue. In other words, after an incident light 204 enters a PBS 200, for example, a light having a polarization state is reflected to the reflective displaying panel 202, and the polarization state of each sub-pixel is controlled and changed according to the desired grey level, then the light enters and passes through the PBS 200, so as to reach a projection lens 206. Therefore, a single-piece display panel is achieved.

The above reflective displaying panel 202 basically still uses red, green and blue as three primary colors to form the desired image color. FIG. 3 is a schematic cross-sectional view of a conventional pixel structure. Referring to FIG. 3, three pixel electrodes 302R, 302G, and 302B corresponding to red, green, and blue are provided on a substrate 300. An absorption layer 304 covers the electrodes 302R, 302G, and 302B. Three optical films 306R, 306G, and 306B corresponding to red, green, and blue reflect the red light, the green light, and the blue light. An alignment layer 308 covers the optical films 306R, 306G, and 306B. An electrode layer 314 and an alignment layer 312 are disposed above another substrate 316. The liquid crystal layer 310 is disposed between the alignment layer 308 and the alignment layer 312. Thereby, a pixel is constituted by three primary colors of red, green, and blue, so as to respectively control the grey level values thereof to achieve the desire color.

In the above method, the color light is constituted by red, green, and blue, and thus if the range of the grey level value is not sufficient, the color saturation of the image will be affected. The persons in this field continue to seek the technique for improving the image color saturation, so as to improve the image quality.

### SUMMARY OF THE INVENTION

The present invention is directed to providing a multi-primary-color digital light splitting and combining system and method, which uses more primary colors to form an image, so as to at least improve the color saturation.

The present invention is further directed to providing a digital projector, which uses the above light splitting and combining system to form an image, so as to improve the image quality of the projector.

The present invention provides a multi-primary-color digital light splitting and combining system, which includes a dichroic device receiving an incident light beam and splitting into a first light beam having a first wavelength range and a second light beam having a second wavelength range. A wavelength value of the first wavelength range is larger than that of the second wavelength range. A first polarization beam splitter (PBS) receives the first light beam and splits out a first polarization beam having a first predetermined polarization state. A second PBS receives the second light beam and splits out a second polarization beam having a second predetermined polarization state. A first reflective displaying panel receives the first polarization beam, and reflects a first set of image information corresponding to a plurality of primary colors. A second reflective displaying panel receives the second polarization beam, and reflects a second set of image information corresponding to a plurality of primary colors. A PBS at the back end receives and combines the first set of image information and the second set of image information to form an image light beam.

In the multi-primary-color digital light splitting and combining system according to an embodiment of the present invention, for example, the first wavelength range is substantially 650 nm-700 nm, and the second wavelength range is substantially 400 nm-650 nm.

In the multi-primary-color digital light splitting and combining system according to an embodiment of the present invention, for example, the first set of image information includes three image information of red, yellow, and green, the second set of image information includes three image information of magenta, blue, and cyan.

In the multi-primary-color digital light splitting and combining system according to an embodiment of the present invention, for example, the first set of image information includes image information of at least two primary colors, the second set of image information includes image information of at least two primary colors, and the first wavelength range and the second wavelength range compose a full wavelength range of a visible light.

In the multi-primary-color digital light splitting and combining system according to an embodiment of the present invention, for example, the first reflective displaying panel and the second reflective displaying panel respectively include a plurality of pixels to constitute a pixel array. Each of the pixels includes a plurality of sub-pixels respectively corresponding to the primary colors.

The present invention also provides a digital projector, which is constituted by the above multi-primary-color digital light splitting and combining system together with an incident light source system and a projection lens system.

The present invention also provides a multi-primary-color digital light splitting and combining method, which includes providing a dichroic device receiving an incident light beam and splitting into a first light beam having a first wavelength range and a second light beam having a second wavelength range. A wavelength value of the first wavelength range is larger than that of the second wavelength range. Also, the first light beam is received and a first polarization beam having a first predetermined polarization state is split out, and the second light beam is received and a second polarization beam having a second predetermined polarization state is split out. The first polarization beam is received by a first reflective displaying panel, and a first set of image information corresponding to a plurality of primary colors is reflected by the first reflective displaying panel. The second polarization beam is received by a second reflective displaying panel and a second set of image information corresponding to a plurality of primary colors is reflected by the second reflective displaying panel. The first set of image information and the second set of image information are combined to form an image light beam.

In order to make the aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a conventional projection display device.

FIG. 2 is a schematic structural view of a conventional multi-color LCOS panel.

FIG. 3 is a schematic cross-sectional view of a conventional pixel structure.

FIG. 4 is a schematic structural view of a digital projector constituted by a multi-primary-color digital light splitting and combining system according to an embodiment of the present invention.

FIG. 5 is a schematic structural view of a reflective displaying panel 414 in FIG. 4.

FIG. 6 is a schematic structural view of a reflective displaying panel 418 in FIG. 4.

FIG. 7 is a schematic structural view of the multi-primary-color digital light splitting and combining system according to the embodiment of the present invention.

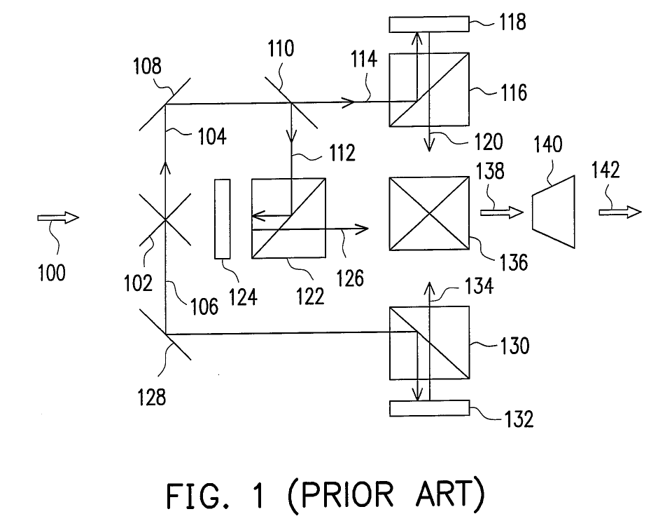

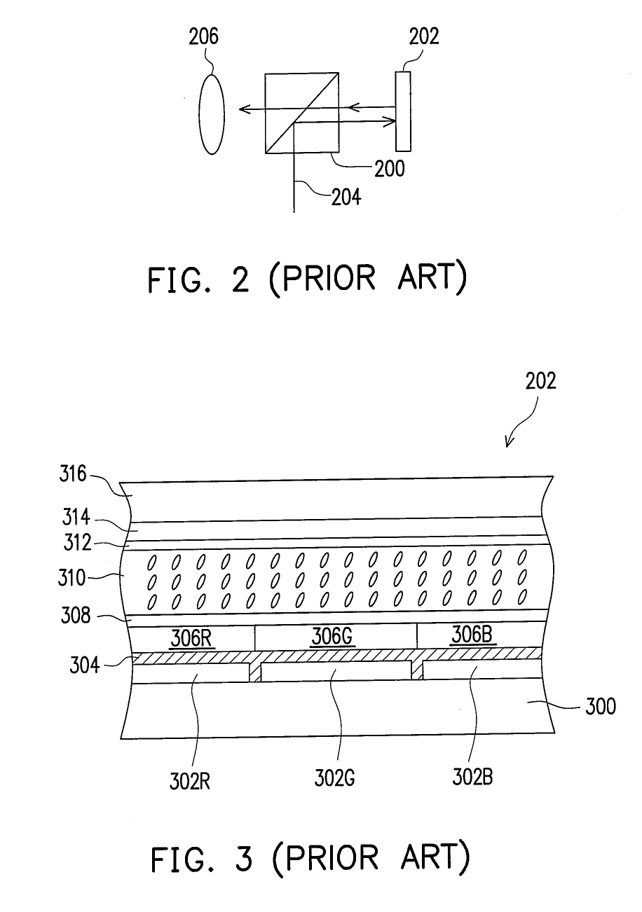

### DESCRIPTION OF EMBODIMENTS

The present invention uses more primary colors to form an image, so as to at least improve the color saturation. Preferably, in the present invention, for example, a beam with wavelength components containing red (R), yellow (Y), and green (G) components, and another beam with wavelength components containing magenta (M), blue (B), and cyan (C) components are used. The six primary colors are respectively filtered out by a filter effect, and the grey level values thereof are controlled. At last, the separated images corresponding to the six primary colors are combined to form an image. Therefore, the image quality is improved. Some embodiments are given below for illustrating the present invention, but not for limiting the present invention.

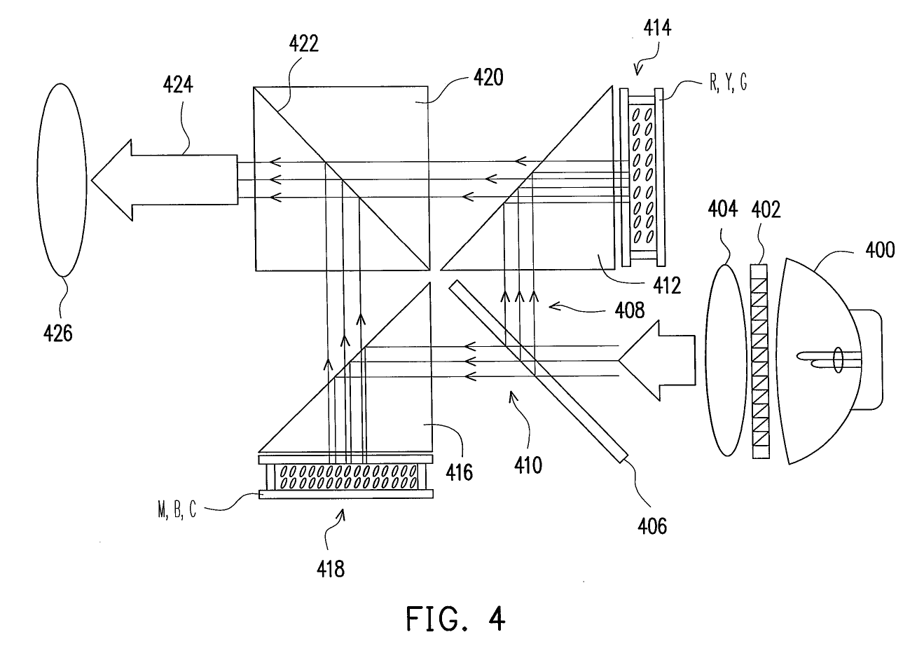

FIG. 4 is a schematic structural view of a digital projector constituted by a multi-primary-color digital light splitting and combining system according to an embodiment of the present invention. Referring to FIG. 4, a light source system, for example, includes a light source unit 400, an optical device 402, and a lens 404. The light source unit 400, for example, provides a white light. The optical device 402 is used to adjust the uniformity of the white light. The lens 404 is used to guide the generated light into the multi-primary-color digital light splitting and combining system.

Then, the multi-primary-color digital light splitting and combining system, for example, includes a dichroic device 406, polarization beam splitting devices 412 and 416, reflective displaying panels 414 and 418, and a polarization beam splitting device 420. The dichroic device 406 receives an incident light beam and splits out the incident light beam into two light beams, for example, a first light beam 408 having a first wavelength range and a second light beam 410 having a second wavelength range. For example, a wavelength value of the first wavelength range is larger than that of the second wavelength range. The first wavelength range is, for example, 650 nm-700 nm and includes red light, yellow light, and green light. The second wavelength range is, for example, 400 nm-650 nm and includes magenta light, blue light, and cyan light.

Herein, generally speaking, the first wavelength range includes at least two primary colors, and the second wavelength range includes at least two primary colors as well. The first wavelength range and the second wavelength range compose a full wavelength range of a visible light. Each primary color can generate corresponding image information together with the subsequent display device, and the detail will be given below.

The split first light beam 408 will enter a polarization beam splitting device 412, and has a feature of reflecting the light of a polarization state and allowing the light of the other polarization state to pass through, but the design on the actual devices is not limited to the specific device structure. In this embodiment, the polarization beam splitting device 412 is a rectangular prism, which can achieve a polarized splitting effect by using a fine structure on the slope, and at least can achieve a polarized splitting effect for the first light beam 408 of the first wavelength range. Similarly, the split second light beam 410 will enter a polarization beam splitting device 416 similar to the polarization beam splitting device 412.

According to an embodiment, a portion of light beam having the first predetermined polarization state in the first light beam 408 is guided into the reflective displaying panel 414, for example, reflected into the reflective displaying panel 414. Meanwhile, a portion of light beam having the second predetermined polarization state in the second light beam 408 is guided into the reflective displaying panel 418, for example, reflected into the reflective displaying panel 418. The reflective displaying panel 414 is used to generate the image information of red light, yellow light, and green light. The reflective displaying panel 418 is used to generate the image information of magenta light, blue light, and cyan light. It should be noted that, the so-called first predetermined polarization state and second predetermined polarization state are determined with reference to the display mechanism of the subsequent reflective displaying panels 414 and 418, and can be the same or different.

In this embodiment, the reflective displaying panel 414 converts the desired grey level value into another polarization state for passing through the polarization beam splitting device 412. However, if the reflective displaying panel 414 is arranged to receive the light of a polarization state passing through the polarization beam splitting device 412, the polarization state of the image information is reflected by the polarization beam splitting device 412. In other words, the desired polarization state and the polarization state to be reflected can be changed according to the actual design mechanism, and the given embodiment is only one example thereof.

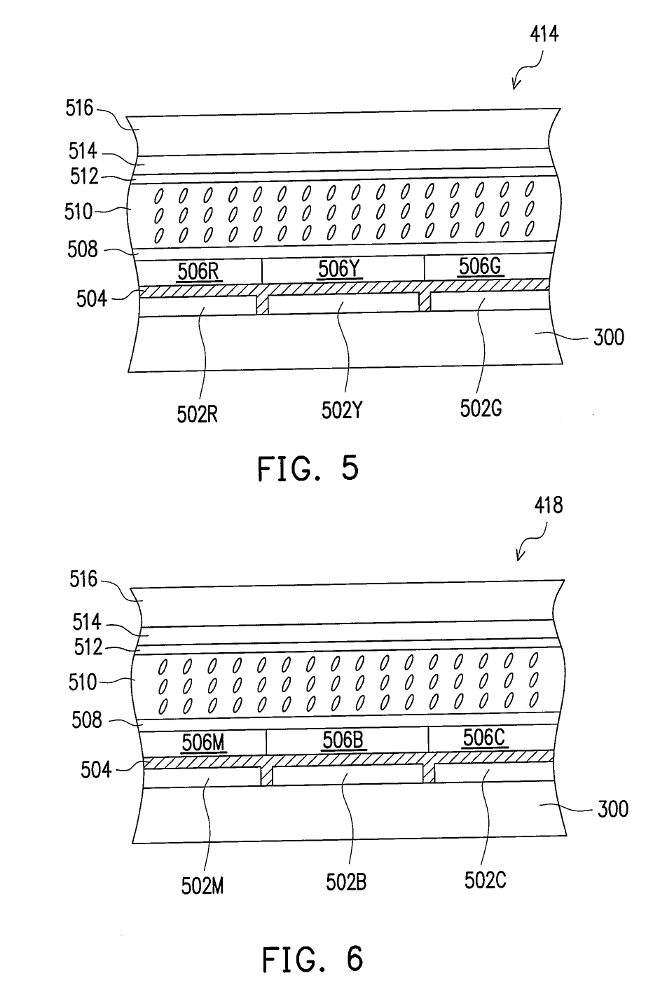

The structure of the reflective displaying panel 414 is, for example, shown in FIG. 5. Referring to FIG. 5, three pixel electrodes 502R, 502Y, and 502G corresponding to red, yellow, and green (RYG) are provided on a substrate 300. An absorption layer 504 covers the electrodes 502R, 502Y, and 502G, so as to absorb the undesired light. Three optical films 506R, 506Y, and 506G corresponding to red, yellow, and green, for example, reflect the red light, the yellow light, and the green light, and the passing light is absorbed by the absorption layer 504. An alignment layer 508 covers the optical films 506R, 506Y, and 506G. An electrode layer 514 and an alignment layer 512 are disposed above another substrate 516. A liquid crystal layer 510 is disposed between the alignment layer 508 and the alignment layer 512. A pixel is constituted by three sub-pixels of three primary colors of red light, yellow light, and green light, so as to respectively generate three image information corresponding to the primary colors such as image grey level values, which is achieved for example by a commonly known mechanism of changing the polarization state. Furthermore, FIG. 6 is a schematic structural view of a reflective displaying panel 418. Referring to FIG. 6, FIG. 6 is similar to FIG. 5, except that optical films 506M, 506B, and 506C are three image information corresponding to magenta light, blue light, and cyan light.

Then, the polarization beams respectively passing through the polarization beam splitting device 412 and 416 enter the PBS 420 at the back end, and the image information of the primary colors are combined to form an image light beam 424 through a light splitting and combining interface 422. The image light beam 424 then projects the image by a projection system, such as a projection mirror 426, to the position where the image is to be displayed.

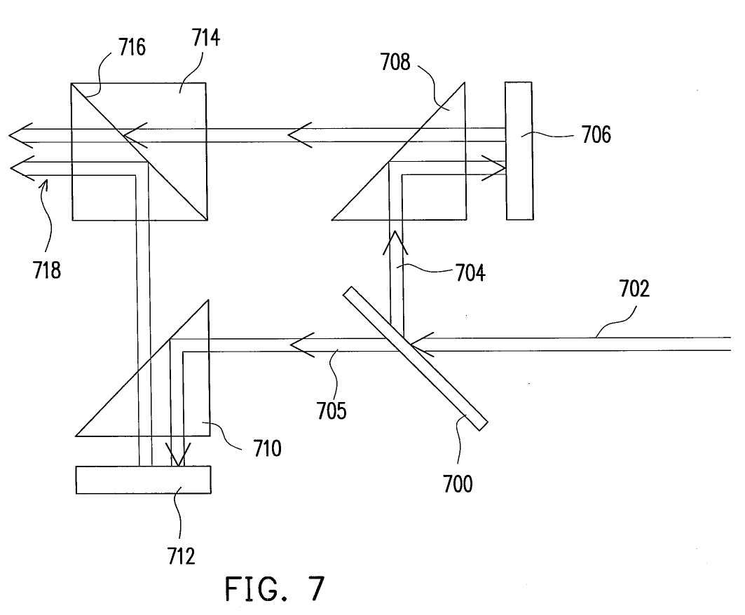

The structure of six primary colors is taken as an example, but is not the only choice. FIG. 7 is a schematic structural view of the multi-primary-color digital light splitting and combining system according to the embodiment of the present invention. The multi-primary-color digital light splitting and combining system, for example, includes a dichroic device 700, polarization beam splitting devices 708 and 710, reflective displaying panels 706 and 712, and a polarization beam splitting device 714.

The dichroic device 700 receives an incident light beam 702, and splits out the incident light beam 702 into two light beams 704, 705. The light beam 704 has a first wavelength range and the light beam 705 has a second wavelength range, for example, a wavelength value of the first wavelength range is larger than that of the second wavelength range. The first wavelength range includes a light of at least two primary colors. The second wavelength range includes alight of at least another two primary colors. The first wavelength range and the second wavelength range compose a full wavelength range of a visible light. The two light beams 704 and 705 respectively enter the polarization beam splitting devices 708 and 710. Light beams having predetermined polarization states are generated by the polarization beam splitting devices 708 and 710, and then respectively guided into the reflective displaying panels 706 and 712. The reflective displaying panels 706 and 712 changes the polarization state of the grey level value desired by each corresponding primary color through controlling the rotation angle of the liquid crystal molecules. When a light splitting effect is conducted on the light guided into the reflective displaying panels 706 and 712 by the polarization beam splitting devices 708 and 710, the image information is split out to combine into an image light beam containing a plurality of primary colors. Then, a light combining is conducted on an interface 716 by the PBS 714 at the back end, so as to obtain an image light beam 718.

From the view of method, the present invention also provides a multi-primary-color digital light splitting and combining method. The light splitting and combining method fitted with the above devices, for example, includes providing a dichroic device receiving an incident light beam and splitting into a first light beam having a first wavelength range and a second light beam having a second wavelength range, and a wavelength value of the first wavelength range is larger than that of the second wavelength range. Also, the first light beam is received and a first polarization beam having a first predetermined polarization state is split out, and the second light beam is received and a second polarization beam having a second predetermined polarization state is split out. The first polarization beam is received by a first reflective displaying panel and a first set of image information respectively corresponding to a plurality of primary colors is reflected by the first reflective displaying panel, and the second polarization beam is received by a second reflective displaying panel and a second set of image information respectively corresponding to a plurality of primary colors is reflected by the second reflective displaying panel. The first set of image information and the second set of image information are combined to form an image light beam.

Conventionally, three primary colors of red, green, and blue are used to form a desired color, when the number of the prey scale state of each primary color is determined, the color performance is poor. In the design of the present invention of using more than three primary colors of red, green, and blue to form a desired color, when the number of the prey scale state is the same, the color change is abundant, and the image quality is thus improved.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

What is claimed is:

1. A multi-primary-color digital light splitting and combining system, comprising:
a dichroic device, receiving an incident light beam and splitting into a first light beam having a first wavelength range and a second light beam having a second wavelength range, wherein a wavelength value of the first wavelength range is larger than that of the second wavelength range;
a first polarization beam splitter (PBS), receiving the first light beam and splitting out a first polarization beam having a first predetermined polarization state;
a second PBS, receiving the second light beam and splitting out a second polarization beam having a second predetermined polarization state;
a first reflective displaying panel, receiving the first polarization beam, and reflecting a first set of image information respectively corresponding to a plurality of primary colors;
a second reflective displaying panel, receiving the second polarization beam, and reflecting a second set of image information respectively corresponding to a plurality of primary colors; and
a PBS at the back end, receiving and combining the first set of image information and the second set of image information to form an image light beam.

2. The multi-primary-color digital light splitting and combining system as claimed in claim 1, wherein the first wavelength range is substantially 650 nm -700 nm, and the second wavelength range is substantially 400 nm-650 nm.

3. The multi-primary-color digital light splitting and combining system as claimed in claim 1, wherein the first set of image information comprises three image information of red, yellow, and green.

4. The multi-primary-color digital light splitting and combining system as claimed in claim 1, wherein the second set of image information comprises three image information of magenta, blue, and cyan.

5. The multi-primary-color digital light splitting and combining system as claimed in claim 1, wherein the first set of image information comprises image information of at least two primary colors, the second set of image information comprises image information of at least two primary colors, and the first wavelength range and the second wavelength range compose a full wavelength range of a visible light.

6. The multi-primary-color digital light splitting and combining system as claimed in claim 1, wherein the incident light beam comprises a white light.

7. The multi-primary-color digital light splitting and combining system as claimed in claim 1, wherein the first reflective displaying panel comprises a plurality of pixels to constitute a pixel array, wherein each of the pixels comprises a plurality of sub-pixels respectively corresponding to the primary colors.

8. The multi-primary-color digital light splitting and combining system as claimed in claim 1, wherein the second reflective displaying panel comprises a plurality of pixels to constitute a pixel array, wherein each of the pixels comprises a plurality of sub-pixels respectively corresponding to the primary colors.

9. A digital projector, comprising:
a light source system, providing a white light beam;
a dichroic device, receiving the white light beam and splitting into a first light beam and a second light beam, wherein the first light beam has a first wavelength range comprising a first set of primary colors, and the second light beam has a second wavelength range comprising a second set of primary colors;
a first PBS, receiving the first light beam and splitting out a first polarization beam having a first predetermined polarization state;
a second PBS, receiving the second light beam and splitting out a second polarization beam having a second predetermined polarization state;
a first reflective displaying panel, receiving the first polarization beam, and reflecting a first set of image information respectively corresponding to the first set of primary colors;
a second reflective displaying panel, receiving the second polarization beam, and reflecting a second set of image information respectively corresponding to the second set of primary colors;
a PBS at the back end, receiving and combining the first set of image information and the second set of image information to form an image light beam; and
a projection lens system, receiving the image light beam to project a display image.

10. The digital projector as claimed in claim 9, wherein the first set of image information comprises three image information of red, yellow, and green.

11. The digital projector as claimed in claim 9, wherein the second set of image information comprises three image information of magenta, blue, and cyan.

12. The digital projector as claimed in claim 9, wherein the first set of image information comprises image information of at least two primary colors, the second set of image information comprises image information of at least two primary colors, and the first wavelength range and the second wavelength range compose a full wavelength range of a visible light.

13. The digital projector as claimed in claim 9, wherein the incident light beam comprises a white light.

14. The digital projector as claimed in claim 9, wherein the first reflective displaying panel comprises a plurality of pixels to constitute a pixel array, wherein each of the pixels comprises a plurality of sub-pixels respectively corresponding to the primary colors.

15. The digital projector as claimed in claim 9, wherein the second reflective displaying panel comprises a plurality of pixels to constitute a pixel array, wherein each of the pixels comprises a plurality of sub-pixels respectively corresponding to the primary colors.

16. A multi-primary-color digital light splitting and combining method, comprising:
providing a dichroic device, for receiving an incident light beam and splitting into a first light beam having a first wavelength range and a second light beam having a second wavelength range, wherein a wavelength value of the first wavelength range is larger than that of the second wavelength range;
receiving the first light beam and splitting out a first polarization beam having a first predetermined polarization state;
receiving the second light beam and splitting out a second polarization beam having a second predetermined polarization state;
receiving the first polarization beam by a first reflective displaying panel, and reflecting a first set of image information respectively corresponding to a plurality of primary colors by the first reflective displaying panel;
receiving the second polarization beam by a second reflective displaying panel, and reflecting a second set of image information respectively corresponding to a plurality of primary colors by the second reflective displaying panel; and
combining the first set of image information and the second set of image information to form an image light beam.

17. The multi-primary-color digital light splitting and combining method as claimed in claim 16, wherein the first wavelength range is substantially 650 nm-700 nm, and the second wavelength range is substantially 400 nm-650 nm.

18. The multi-primary-color digital light splitting and combining method as claimed in claim 16, wherein the first set of image information comprises three image information of red, yellow, and green.

19. The multi-primary-color digital light splitting and combining method as claimed in claim 16, wherein the second set of image information comprises three image information of magenta, blue, and cyan.

20. The multi-primary-color digital light splitting and combining method as claimed in claim 16, wherein the first set of image information comprises image information of at least two primary colors, the second set of image information comprises image information of at least two primary colors, and the first wavelength range and the second wavelength range compose a full wavelength range of a visible light.
